(19) United States
(12) Patent Application Publication
(10) Pub. No.: US 2005/0097758 A1
(43) Pub. Date: May 12, 2005

(54) Tool for cutting cable ties leaving a round end

(76) Inventor: Bert Vinson Elkins, Escondido, CA (US)

Correspondence Address: Bert V. Elkins, 10626 Cerveza Dr., Escondido, CA, 92026, US

(21) Appl. No.: 10/705,348

(22) Filed: Nov. 10, 2003

(51) Int. Cl. B26B 13/00

(52) U.S. Cl. 30/233

(57) ABSTRACT

The present invention presents pliers like hand tools with special shaped cutting edges in the jaws of the tool that when used to cut off the unwanted ends of cable ties the cut end of the cable tie is a smooth rounded end.

### CROSS-REFERENCE TO RELATED APPLICATIONS

There are no related Applications.

### STATEMENT REGARDING FEDERALLY SPONSORED RESEARCH AND DEVELOPMENT

There is no federally sponsored research and development in regards to this application.

### REFERENCE TO A “MICROFICHE APPENDIX”

There are no microfiche in regard to this application.

### BACKGROUND OF INVENTION

1. Field of Invention

Plastic straps or bands with a self locking head on one end and ridges across the strap on one side that are designed to form a locked tie loop when the free end of the strap is threaded through the self locking head on the other end of the strap are known in the industry as Cable Ties and sometimes referred to as Wire Ties. Cable ties are use to secure many things such as holding a number of electrical wires together in a bundle or securing wires or a cable to a beam or wall, and are being used in more and more applications as time goes on. When a cable tie is used there is an unwanted length of tie extending beyond the tie locking devise. To remove this unwanted length of cable tie the present art is to use a knife, scissors, nippers or shears to cut off the unwanted length of tie. All of these tools make a square cut on the end of the tie thereby leaving sharp edges on the corners of the cut end of the tie. These sharp edges can cause pain and even cut the skin of the person making contact with them. What is needed is a tool that will cut off the unwanted length of the tie leaving a smooth rounded end on the tie. The tools shown on the drawings as FIGS. 1, 4, 7, 10 and 11 will cut the tie off leaving a smooth rounded end on the tie with no sharp edges.

2. Description of Related Art

Presently to cut off the unwanted length of tie a knife, scissors, nippers, or shears are used. Each of these tools make a straight cut across the end of the tie leaving sharp corners on the edge of the cut. When a person is working around these sharp edges, especially in tight places there is a good chance these sharp edges will prick the person's hands and arms severely enough to cause bleeding. There are special tools that grip the tie and pull it tight around the bundle of wires, cables, etc and cut the unwanted portion of the tie off next to the self locking head, but all of these special tools make a straight cut across the tie leaving sharp corners on the end of the cut tie. I have diligently searched past patents and have not found a patent for a tool that cuts the tie leaving a smooth rounded end on the tie. I have search the market place and have not found a tool that cuts the tie leaving a smooth rounded end on the tie.

### BRIEF SUMMARY OF INVENTION

My invention provides hand tools that are constructed like pliers and provides cutting edges in the jaws of the tools for cutting off the excess length of cable ties leaving a smooth rounded cut on the end of the tie. The smooth rounded cut on the end of the tie eliminates the sharp corners resulting from making a straight cut across the tie when existing tools are used to cut off the excess length of tie.

Presently the most common practice is to use long nose pliers with straight edge wire cutters incorporated in the jaws of the pliers to pull the free end of a cable tie loop tight against the self locking head and to cut the excess length of tie off leaving a square cut with sharp corners. My invention uses a similar pair of pliers incorporating cone shaped cutting edges in the jaws of the pliers instead of the straight edge cutters. When the jaws of the pliers are opened and the free end of the tie is placed between the cone shaped jaw cutters the unwanted length of the tie can be cut off leaving a smooth rounded cut on the end of the tie. This tool is illustrated in the drawings by FIG. 1, FIG. 2, and FIG. 3. This is the preferred tool of my invention since the extended nose on the tool can be used to pull the tie loop tight against the self-locking head.

Another embodiment of my invention is similar to a one-hole punch that contains a round hole in one of the jaws and a round plunger fixed to the other jaw that punches a round hole in the material placed between the jaws when the handles of the punch are squeezed. In my invention the round hole in one jaw is replaced with a semi-circle opening at the end of the jaw and the round plunger in the other jaw is replaced with a concaved semi-circular plunger at the end of the jaw. When the free end of a cable tie is inserted in the tool over the semi-circle in one jaw and the handles are squeezed the concaved semi-circle plunger attached to the other jaw cuts the tie off leaving a smooth rounded end on the end of the tie. One jaw of the tool has an opening in it so that the free end of the tie can pass through the body of the tool. This tool is illustrated in the drawings by FIG. 7 and FIG. 8.

Another embodiment of my invention is similar to end nippers that are constructed like pliers with chisel like cutters at the end of the jaws. This type of nipper does not provide a good tool for cutting off the unwanted length of cable ties because the tool does not provide a means of threading the free end of the tie through the body of the nipper and the cut leaves sharp corners on the end of the tie. My invention replaces the straight chisel like cutters on the end of the jaws of the nipper with semi-circular cutters and provides an opening in the body of the tool for threading the free end of the tie through the tool. When the free end of the tie is threaded through the body of the tool and the handles are squeezed the semi-circular cutters on the end of the jaws cut the tie leaving a smooth rounded end on the tie. This tool is illustrated in the drawings by FIG. 4, FIG. 5, and FIG. 6.

Two other embodiments of my inventing provide two types of cutting edges in the jaws of the tool. The tool with the cone shaped cutting edges is modified by replacing that part of the jaws extending beyond the cone cutters with either of the cutting edges illustrated in the drawings by FIG. 4 and FIG. 5, and FIG. 7 and FIG. 8. These tools are illustrated by the drawings FIG. 10 and FIG. 11.

### DESCRIPTION OF DRAWINGS

The drawings illustrate the present invention applied to five embodiments.

FIGS. 1 through 3 illustrates the preferred embodiment.

FIG. 1 is an isometric view of the tool in use.

FIG. 2 is a top view of the cone shaped cutting edges in use.

FIG. 3 shows the cable tie cut leaving a smooth rounded cut on the end of the remaining cable tie.

FIGS. 4 through 6 illustrates the second embodiment.

FIG. 4 is an isometric view of the second embodiment.

FIG. 5 is a side view of the second embodiment in use.

FIG. 6 shows the cable tie cut leaving a smooth rounded cut on the end of the remaining cable tie.

FIGS. 7 and 8 illustrate the third embodiment.

FIG. 7 is an isometric view of the third embodiment.

FIG. 8 is a side view of the third embodiment

FIG. 9 is a side view of the design of the pivot pin used for all of the embodiments.

FIG. 10 is an isometric view of the fourth embodiment.

FIG. 11 is an isometric view of the fifth embodiment

FIG. 12 is a side view of the clip spring used to open the jaws sufficiently to allow the cable tie to be inserted between the cutting edges.

### DESCRIPTION OF THE PREFERRED EMBODIMENT

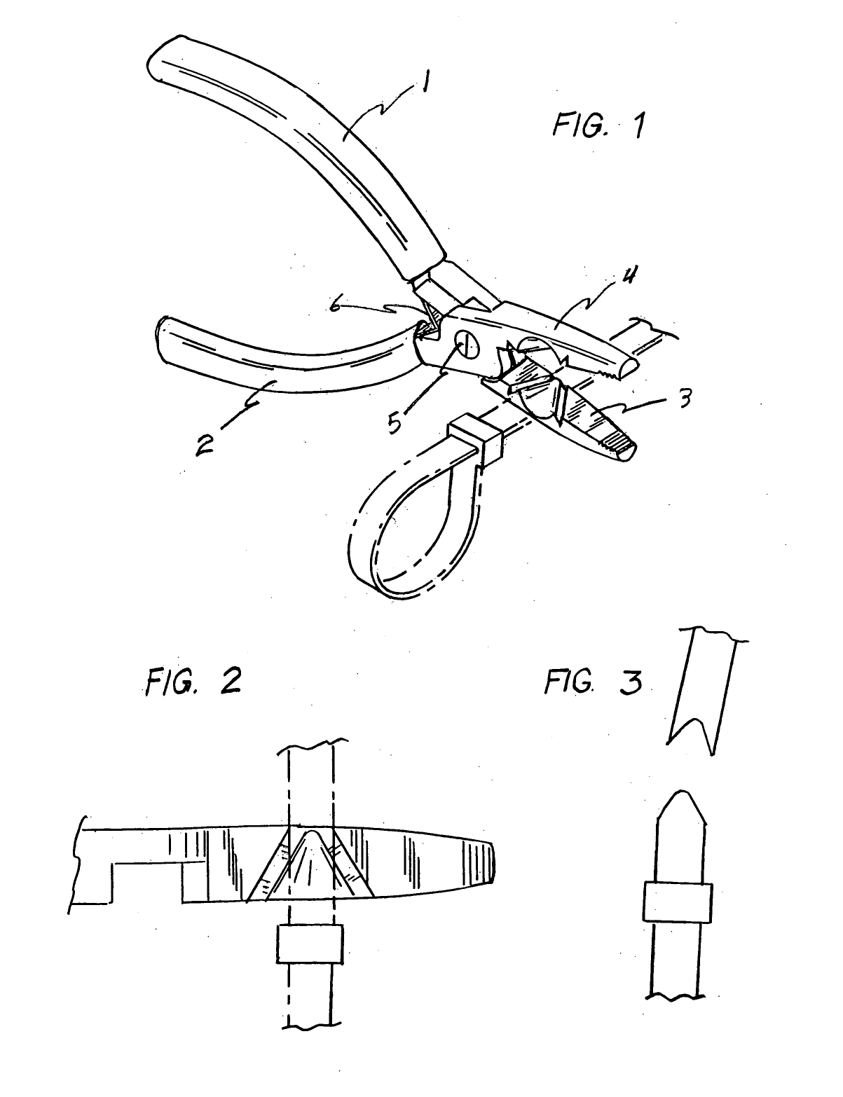

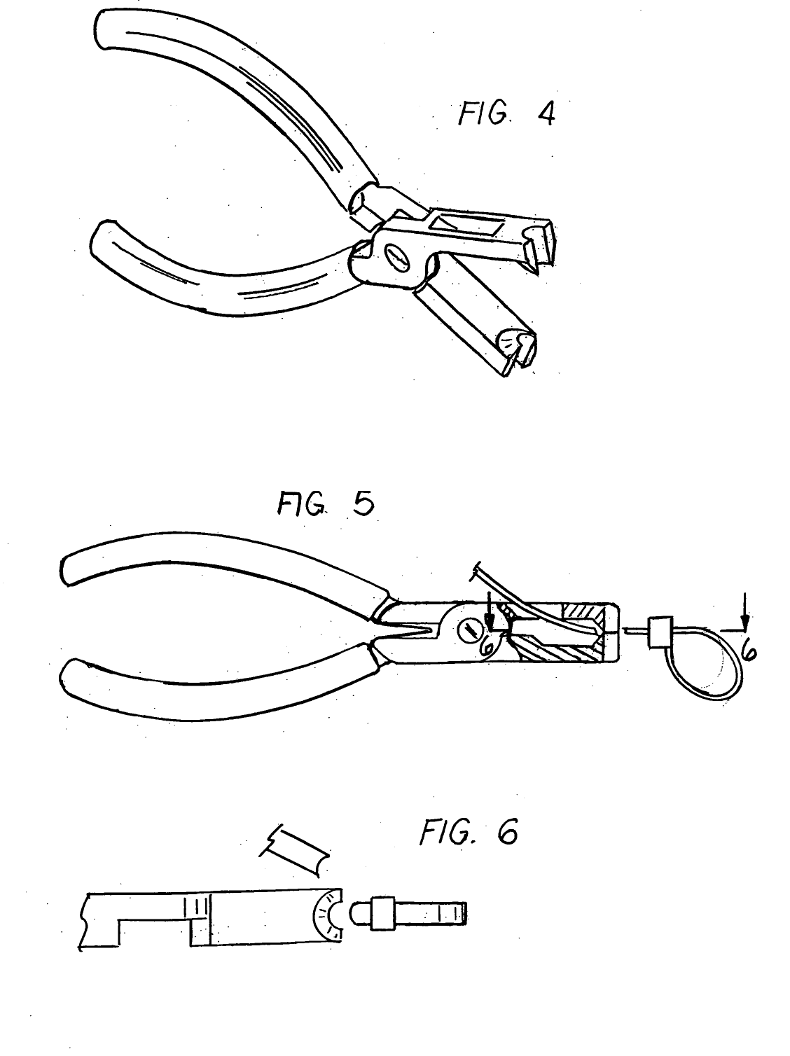

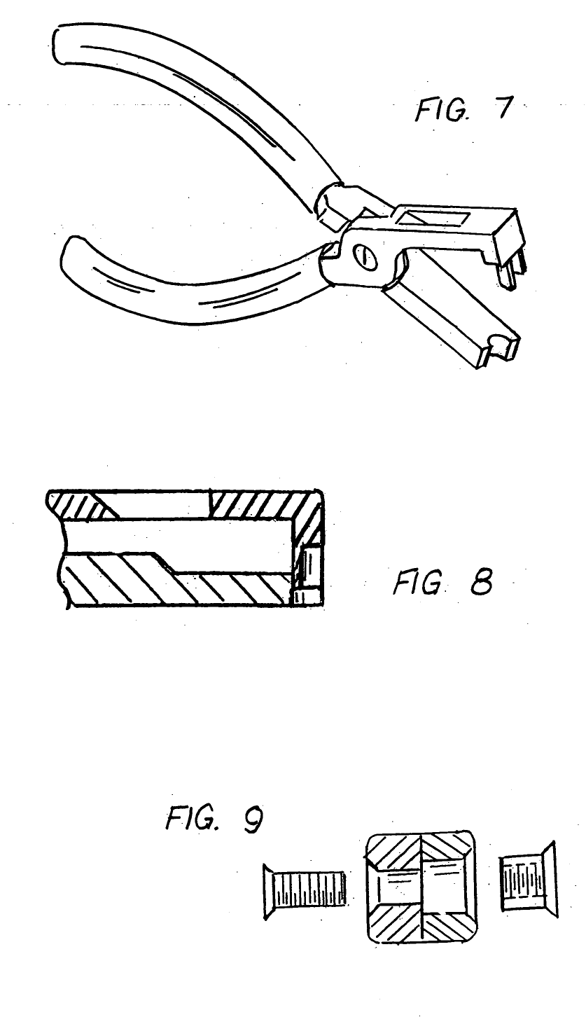

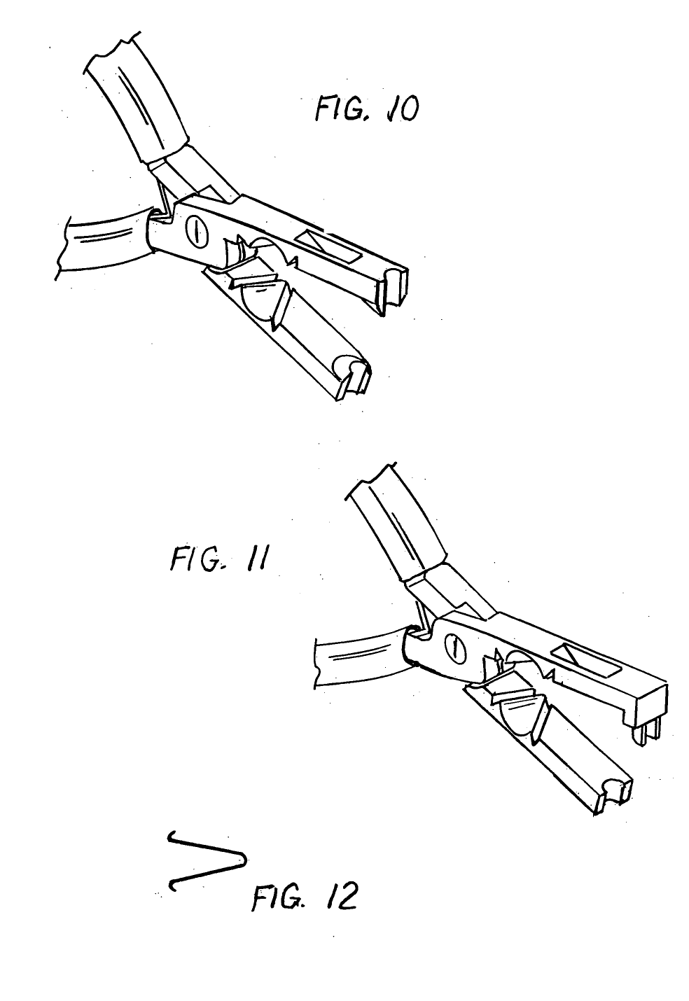

The preferred embodiment of the present invention is a pliers' like tool with special cutting edges and nose grips in the jaws as Illustrated in the drawings by FIGS. 1 and 2. When handles 1 and 2 are squeezed they pivot around pivot 5 compressing the clip spring 6 and close jaws 3 and 4. The closing of the jaws provides a means for griping the end of the cable tie and pulling the end through the self locking head and or to cut the excess cable tie material off when the tie is positioned between the cutting edges. The cut on the remaining end of the tie is a smooth rounded cut.

1. A hand tool for cutting a strap, such as a cable tie, that leaves a smooth rounded end on the cut strap, the tool comprising:
two handles which are connected together in a single plane at a pivot point by means of a pivot connector;
mating cutting jaws carried by said handles; wherein each said cutting jaw comprises a rounded cutting edge; wherein when said cutting jaws are urged towards each other by said handles, said cutting jaws cut through said strap to leave a smooth rounded end on the cut strap.

2. A hand tool in accordance with clam 1, wherein said cutting jaws are located near the pivot point, and wherein said handles further comprise extended gripping jaws for gripping said strap.

3. A hand tool in accordance with clam 2, where in each said cutting jaw comprises a semi-cone shaped cutting edge.

4. A hand tool in accordance with clam 1, further comprising bias means for urging said handles apart.

5. A hand tool in accordance with clam 1, where in one of the said cutting jaws comprises a semi-circle groove cutting edge and the other of said cutting jaws comprises a semi-circle plunger adapted to move into said groove when said cutting jaws are moved against each other; wherein one of said jaws includes an opening enabling a free end of said strap to pass through said opening.

6. A hand tool in accordance with clam 5, wherein each said cutting jaw further comprises a semi-cone shaped cutting edge.
